(19) United States
(12) Patent Application Publication
(10) Pub. No.: US 2022/0244537 A1
(43) Pub. Date: Aug. 4, 2022

(54) OPTICAL ASSEMBLY AND HEAD-MOUNTED APPARATUS

(71) Applicant: Lenovo (Beijing) Limited, Beijing (CN)

(72) Inventors: Chenggang ZOU, Beijing (CN); Xiaopan ZHENG, Beijing (CN); Xiangbo LV, Beijing (CN)

(21) Appl. No.: 17/550,459

(22) Filed: Dec. 14, 2021

(30) Foreign Application Priority Data
Feb. 4, 2021 (CN) 202110155681.9

(51) Int. Cl. G02B 27/01; G02B 27/28

(52) U.S. Cl. CPC G02B 27/0172; G02B 2027/0178; G02B 2027/0138; G02B 27/283

(57) ABSTRACT

An optical assembly includes a prism having a cubical structure, and first, second, third, and fourth imaging devices arranged symmetrically with the prism as a center and each including a lens. The lenses of the first, second, third, and fourth imaging devices are arranged at four sides of the prism, respectively. The optical assembly further includes an image display. The image display outputs light to the first imaging device. The prism performs optical path conversion on the light after the light passes through the lens of the first imaging device, so that the light is output after passing through the lenses of the second, third, and fourth imaging devices.

### CROSS-REFERENCE TO RELATED APPLICATION

This application claims priority to Chinese Patent Application No. 202110155681.9, filed on Feb. 4, 2021, the entire content of which is incorporated herein by reference.

### TECHNICAL FIELD

The present disclosure generally relates to imaging technology field and, more particularly, to an optical assembly and head-mounted apparatus.

### BACKGROUND

In an existing imaging system, due to a limitation of the apparatus space, imaging lenses usually are only arranged at one or two directions, such that an imaging quality of the imaging system is low.

### SUMMARY

In accordance with the disclosure, there is provided an optical assembly including a prism having a cubical structure, and first, second, third, and fourth imaging devices arranged symmetrically with the prism as a center and each including a lens. The lenses of the first, second, third, and fourth imaging devices are arranged at four sides of the prism, respectively. The optical assembly further includes an image display. The image display outputs light to the first imaging device. The prism performs optical path conversion on the light after the light passes through the lens of the first imaging device, so that the light is output after passing through the lenses of the second, third, and fourth imaging devices.

Also in accordance with the disclosure, there is provided a head-mounted apparatus including a body and an optical assembly arranged at the body. The optical assembly includes a prism having a cubical structure, and first, second, third, and fourth imaging devices arranged symmetrically with the prism as a center and each including a lens. The lenses of the first, second, third, and fourth imaging devices are arranged at four sides of the prism, respectively. The optical assembly further includes an image display. The image display outputs light to the first imaging device. The prism performs optical path conversion on the light after the light passes through the lens of the first imaging device, so that the light is output after passing through the lenses of the second, third, and fourth imaging devices.

### BRIEF DESCRIPTION OF THE DRAWINGS

FIG. 1 is a schematic structural diagram of an optical assembly according to an embodiment of the present disclosure.

FIG. 2 is a schematic diagram showing an optical path of an optical assembly according to an embodiment of the present disclosure.

FIG. 3 to FIG. 12 are schematic structural diagrams showing other examples of optical assembly and corresponding optical paths, according to some embodiments of the present disclosure.

FIG. 13 to FIG. 15 are schematic structural diagrams showing a prism of an optical assembly according to some embodiments of the present disclosure.

FIG. 16 to FIG. 18 are schematic structural diagrams showing other examples of optical assembly and corresponding optical paths, according to some embodiments of the present disclosure.

FIG. 19 is a schematic structural diagram of an optical assembly according to another embodiment of the present disclosure.

FIG. 20 is a schematic structural diagram of a head-mounted apparatus according to an embodiment of the present disclosure.

FIG. 21 to FIG. 23 are schematic diagrams showing examples of the present disclosure applied to VR glasses.

### DETAILED DESCRIPTION OF THE EMBODIMENTS

The technical solutions of embodiments of the present disclosure are described in detail in conjunction with accompanying drawings of embodiments of the present disclosure. The described embodiments are only some embodiments not all embodiments of the present disclosure. Based on embodiments of the present disclosure, all other embodiments obtained by those of ordinary skill in the art without any creative work are within the scope of the present disclosure.

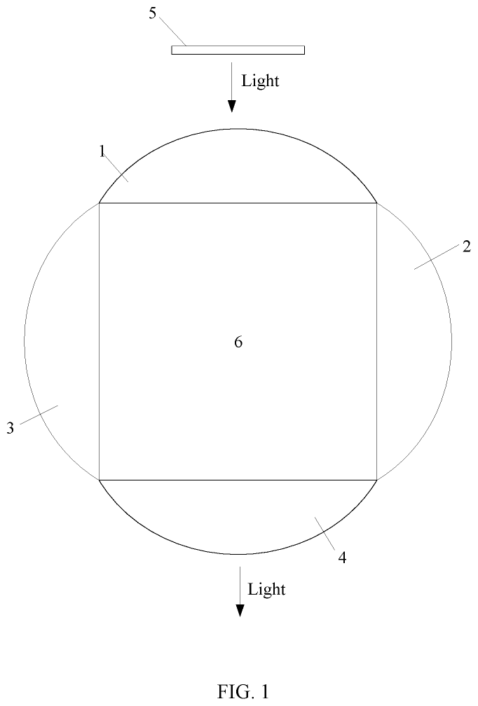

FIG. 1 is a schematic structural diagram of an optical assembly according to some embodiments of the present disclosure. The optical assembly is a structure that may be arranged at a head-mounted apparatus and is configured to capture an image. The technical solution of the present disclosure is adopted to improve imaging quality of the optical assembly.

In some embodiments, the optical assembly includes a first imaging device 1, a second imaging device 2, a third imaging device 3, a fourth imaging device 4, an image display 5, and a prism 6 having a cubical structure. The image display 5 is also referred to as an “image display source.”

The first imaging device 1, the second imaging device 2, the third imaging device 3, and the fourth imaging device 4 all include lenses. The lens of the first imaging device 1, the lens of the second imaging device 2, the lens of the third imaging device 3, and the lens of the fourth imaging device 4 are arranged at the four sides of the prism 6, respectively, and four imaging devices are arranged symmetrically with the prism 6 as a center.

After the image display 5 of the optical assembly transmits light to the lens of the first imaging device 1, the prism 6 performs optical path conversion on the light after the light passes through the lens of the first imaging device 1, so that the light having passed through the first imaging device 1 is output after the light passes through the lens of the second imaging device 2, the lens of the third imaging device 3, and the lens of the fourth imaging device 4, respectively.

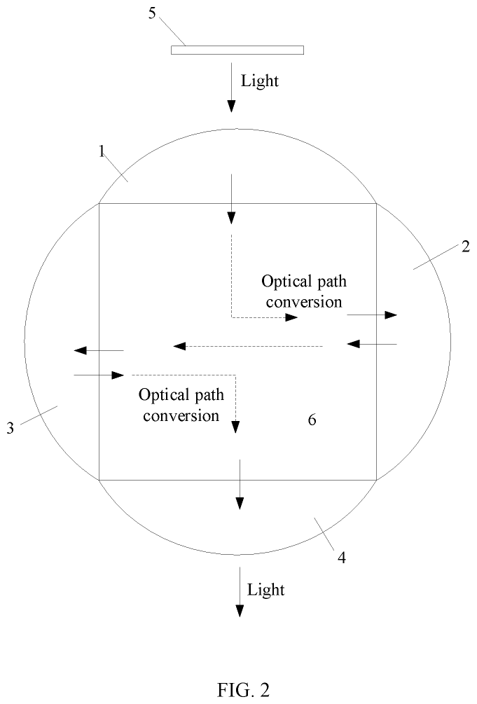

As shown in FIG. 2, an angle of each of the lens of the first imaging device 1, the lens of the second imaging device 2, the lens of the third imaging device 3, and the lens of the fourth imaging device 4 relative to a side of the prism 6 is adjusted, such that light output by the image display for the output image enters the prism 6 after the light passing through the lens of the first imaging device 1, the prism 6 performs optical path conversion on the light, the light enters the prism 6 again after entering the lens of the second imaging device 2 and passing through the lens of the second imaging device 2, the prism 6 performs optical path conversion on the light again, the light enters the prism 6 again after entering the lens of the third imaging device 3 and passing through the lens of the third imaging device 3, the prism 6 performs optical path conversion on the light again, and the light is output by the fourth imaging device 4 after entering the lens of the fourth imaging device 4 and passing through the lens of the fourth imaging device 4. In the above-described process, the light output by the image display for the image to be output passes through the lenses at least four times, and each time the lens can perform a phase difference correction and a stray light filtering on the light when the light passes through the lens. As such, the image quality of the output light can be improved.

An embodiment of the present disclosure provides an optical assembly. The optical assembly includes a prism having a cubical structure, an image display, and four imaging devices. The four imaging devices include the first imaging device, the second imaging device, the third imaging device, and the fourth imaging device. The four imaging devices all include lenses. The lenses of the four imaging devices are arranged at the four sides of the prism 6, respectively, and the four imaging devices are arranged symmetrically with the prism 6 as a center. As such, after the image display outputs light to the lens of the first imaging device, the prism performs optical path conversion on the light after the light passes through the lens of the first imaging device, the light having passed through the lens of the first imaging device may be output after the light passes through the lens of the second imaging device, the lens of the third imaging device, and the lens of the fourth imaging device. In some embodiments of the present disclosure, four imaging devices with lenses are arranged at the four sides of the prism of the optical assembly, respectively. As such, the light output from the image display may pass through a plurality of lenses because of the optical path conversion feature of the prism. Thus, more lenses can be arranged in the lenses, hence phase difference correction and stray light filtering can be performed on the light for multiple times using the lenses, thereby improving the imaging quality of the optical assembly.

In some embodiments, the prism 6 has a cubical structure. A layer of beam splitter film 61 may be arranged at the prism 6 to realize the optical path conversion for the light, and the beam splitter film 61 may be arranged at a diagonal cross-section of the cubical structure.

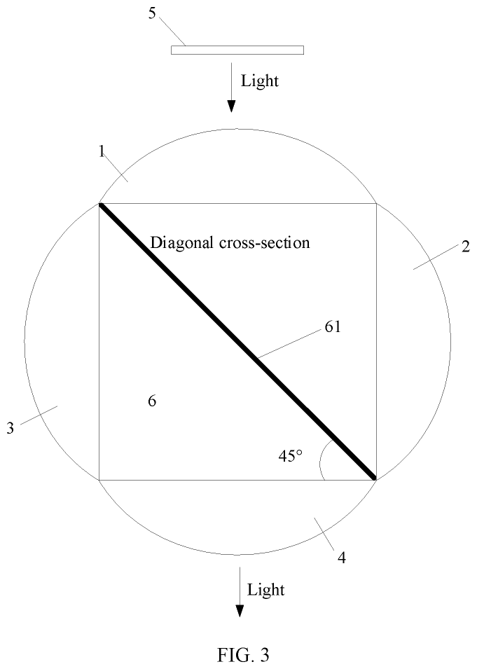

In some embodiments, the beam splitter film 61 may be arranged at the diagonal cross-section of the prism 6 by embedding. As shown in FIG. 3, the beam splitter film 61 located at the diagonal cross-section forms an angle of 45° with each of the imaging devices provided at the four sides of the prism 6, respectively, thereby enabling the beam splitter film 61 of the prism 6 to reflect or transmit the light entering the beam splitter film 61, so that the light passing through the lens of the first imaging device 1 are output after the light passes through the lens of the second imaging device 2, the lens of the third imaging device 3, and the lens of the fourth imaging device 4. As a result, the optical path conversion performed by the beam splitter film 61 of the prism 6 enables the light output by the image display for the image to be output to pass through the lenses of the imaging devices of the optical assembly sequentially, thereby improving the imaging quality of the output light.

In some embodiments, the beam splitter film 61 reflects the light after the light passes through the lens of the first imaging device 1 to cause the light to enter the lens of the second imaging device 2. Then, after the light passes through the lens of the first imaging device 1 and the lens of the second image device 2, the beam splitter film 61 allows the light to enter the lens of the third imaging device 3. Further, the beam splitter film 61 reflects the light after the light passes through the lens of the first imaging device 1, the lens of the second imaging device 2, and the lens of the third imaging device 3, so as to cause the reflected light to enter the lens of the four imaging devices 4.

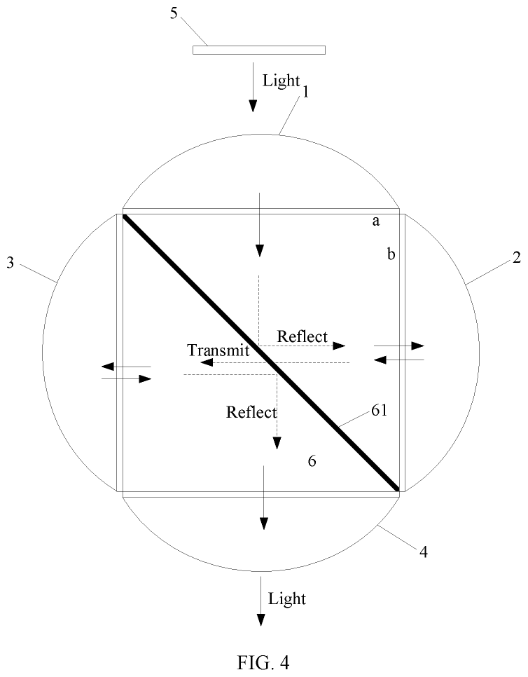

As shown in FIG. 4, the light output by the image display for the image to be output enters the lens of the first imaging device 1 and passes through the lens of the first imaging device 1, and then enters the prism 6. The beam splitter film 61 located at the diagonal cross-section of the prism 6 reflects the light to cause the light to enter the lens of the second imaging device 2. The light enters the lens of the second imaging device 2 and is reflected by the lens of the second imaging device 2 and then enters the prism 6 again. At this time, the beam splitter film 61 allows the light to pass through to enter the lens of the third imaging device 3. The light enters the lens of the third imaging device 3 and is reflected by the lens of the third imaging device 3 and then enters the prism 6 again. The beam splitter film 61 reflects the light again to cause the light to enter the lens of the fourth imaging device 4, and finally, the light enters the lens of the fourth imaging device 4 and passes through the lens of the fourth imaging device 4 and then output by the fourth imaging device 4. In this process, the light output by the image display for the image to be output passes through the lenses at least four times, and each time the light is subject to phase difference correction and stray light filtering, thereby improving the imaging quality of the output light.

In some embodiments, the beam splitter film 61 may be a polarization beam splitter film 61, and the polarization beam splitter film 61 may select whether to reflect or transmit the light according to a polarization state of the light entering the polarization beam splitter film 61.

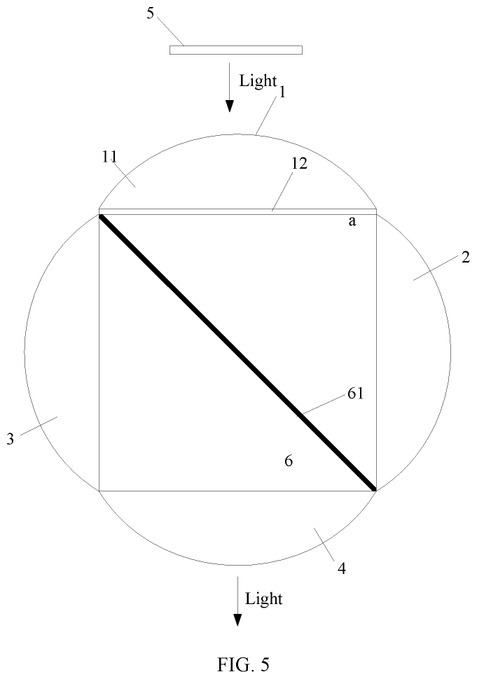

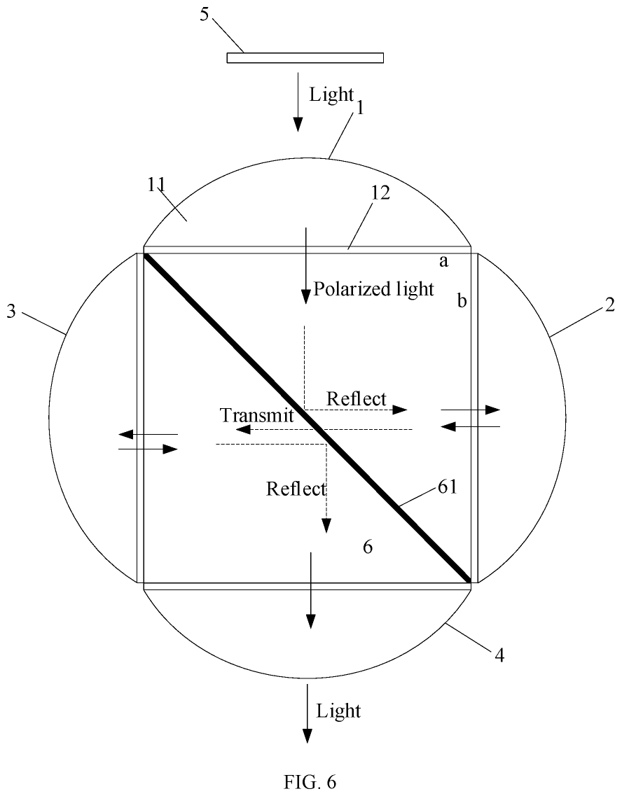

In some embodiments, the lens of the first imaging device 1 may be a transmissive lens 11, and the first imaging device 1 further includes a polarization plate 12, as shown in FIG. 5. The polarization plate 12 of the first imaging device 1 is glued between the transmissive lens 11 of the first imaging device 1 and one side (side a) of the prism 6. After the light is output by the image display 5 for the image to be output enter the first imaging device 1, the light first enters the transmissive lens 11 of the first imaging device 1, then the light enters the polarization plate 12 of the first imaging device 1. At this time, the polarization plate 12 of the first imaging device 1 performs a polarization conversion on the light after the light passes through the transmissive lens 11 of the first imaging device 1, that is, the light is converted into polarized light by the polarization plate 12 of the first imaging device 1. The light subjected to the polarization conversion, i.e., the light that is converted to polarization light, is light that can be reflected by the beam splitter film 61. As such, the light having passed through the transmissive lens 11 and the polarization plate 12 of the first imaging device 1 enters the second imaging device 2 after being reflected by the beam splitter film 61, as shown in FIG. 6.

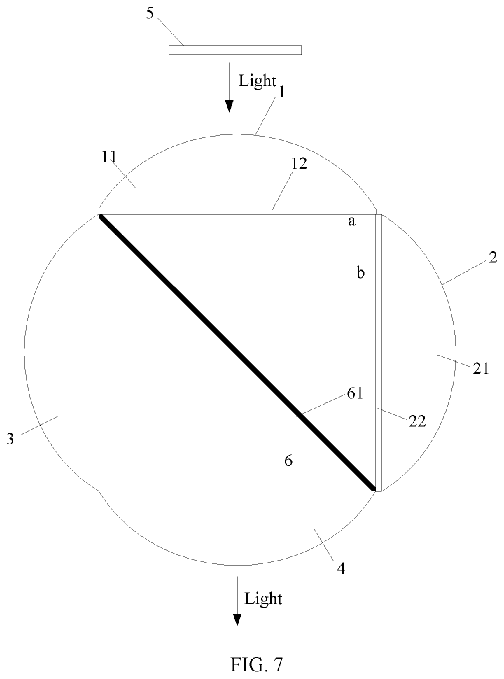

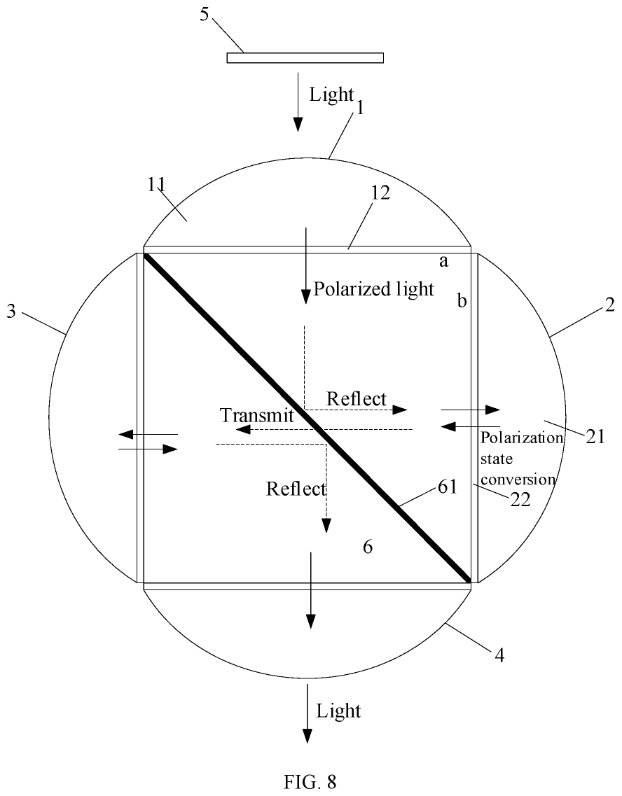

In the second imaging device 2, the lens of the second imaging device 2 is a reflective lens 21, and the second imaging device 2 also includes a quarter-wave plate 22, as shown in FIG. 7. The quarter-wave plate 22 of the second imaging device 2 is glued between the reflective lens 21 of the second imaging device 2 and one side (side b) of the prism 6. As such, the light output by the image display 5 passes through the first imaging device 1 and enters the second imaging device 2 after being reflected by the polarization beam splitter film 61. The light entering the second imaging device 2 first enters the quarter-wave plate 22 of the second imaging device 2, then the light enters the reflective lens 21 of the second imaging device 2. The light enters the quarter-wave plate 22 again after being reflected by the reflective lens 21. In the process, the quarter-wave plate 22 of the second imaging device 2 performs polarization state conversion on the light entering the second imaging device 2. After the polarization state conversion, the light may be transmitted by the polarization beam splitter film 61, so that the light passing through the reflective lens 21 and the quarter-wave plate 22 of the second imaging device 2 enters the third imaging device 3 after the light passes through the polarization beam splitter film 61, as shown in FIG. 8.

In some embodiments, the light entering the second imaging device 2 first passes through the quarter-wave plate 22 and then enters the reflective lens 21 of the second imaging device 2, and then the light passes through the quarter-wave plate 22 again after being reflected by the reflective lens 21 of the second imaging device 2. After the light passes through the quarter-wave plate twice, the polarization state of the light is converted into a polarization state that is different from that of the light before entering the second imaging device 2. In some embodiments, the polarization state of the light that having passed through the quarter-wave plate 22 twice is converted into the light that can be transmitted by the polarization beam splitter film 61, so that the light passing through the reflective lens 21 of the second imaging device 2 enters the third imaging device 3 after being transmitted by the polarization beam splitter film 61.

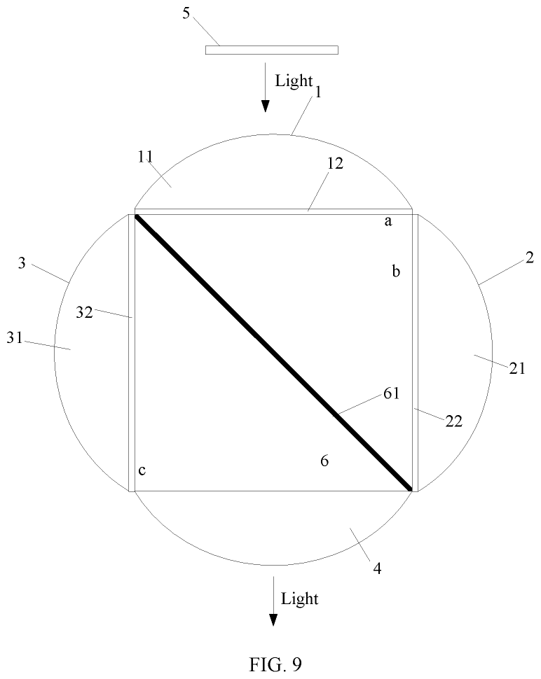

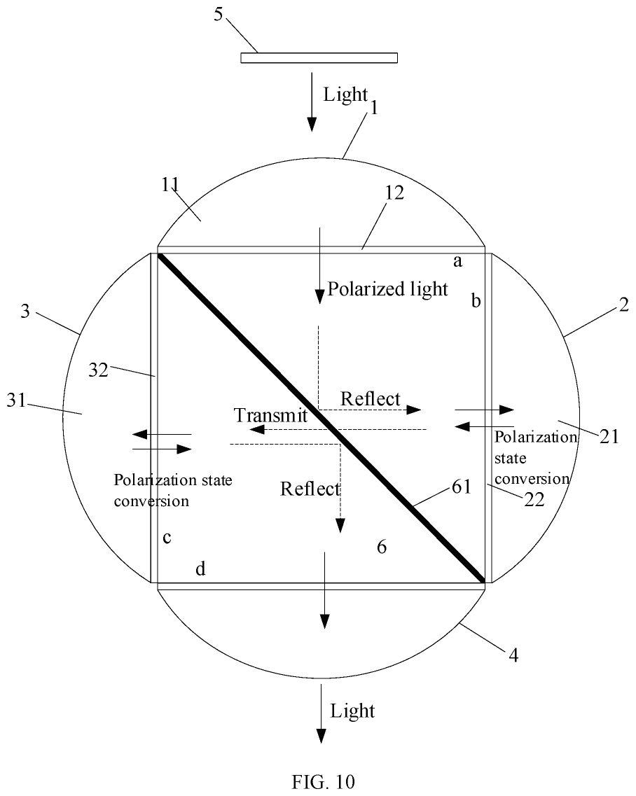

In addition, in the third imaging device 3, the lens of the third imaging device 3 is a reflective lens 31, and the third imaging device 3 further includes a quarter-wave plate 32, as shown in FIG. 9. In some embodiments, the quarter-wave plate 32 of the third imaging device 3 is glued between the reflective lens 31of the third imaging device 3 and one side (side c) of the prism 6. As such, the light output by the image display 5 passes through the first imaging device 1 and enters the second imaging device 2 after being reflected by the polarization beam splitter film 61, and then the light is reflected by the second imaging device 2 and enters the second imaging device 2 after passing through the polarization beam splitter film 61. The light entering the third imaging device 3 first enters the quarter-wave plate 32 of the third imaging device 3, and then enters the reflective lens 31 of the third imaging device 3. The light enters the quarter-wave plate 32 again after being reflected by the reflective lens 31. In the process, the quarter-wave plate 32 of the third imaging device 3 performs polarization state conversion on the light entering the third imaging device 3. The light can be transmitted by the polarization beam splitter film 61 after the polarization state conversion, so that the light passing through the reflective lens 31 of the third imaging device 3 enters the fourth imaging device 4 after the light is transmitted by the polarization beam splitter film 61, as shown in FIG. 10.

In some embodiments, the light having entered the third imaging device 3 first passes through the quarter-wave plate 32 and then enters the reflective lens 31 of the third imaging device 3, and then the light passes through the quarter-wave plate 32 again after being reflected by the reflective lens 31 of the third imaging device 3. The polarization state of the light after the light transmits through the quarter-wave plate 32 twice is converted to a polarization state different from the polarization state of the light before entering the third imaging device 3. In some embodiments, the polarization state of the light after the light passes through the quarter-wave plate 32 twice is converted into the light that can be transmitted by the polarization beam splitter film 61, so that the light transmitted at the reflective lens 31 of the third imaging device 3 enters the fourth imaging device 4 after being transmitted by polarization beam splitter film 61.

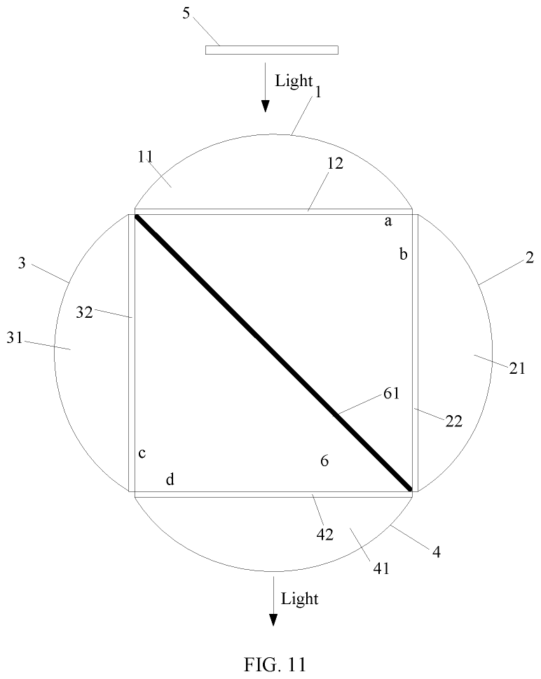

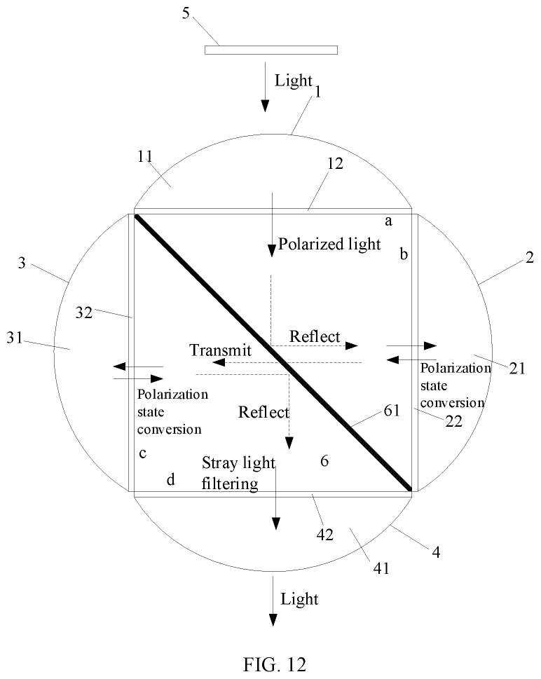

In the fourth imaging device 4, the lens of the fourth imaging device 4 is a transmissive lens 41, and the fourth imaging device 4 further includes a polarization plate 42, as shown in FIG. 11. In some embodiments, the polarization plate 42 of the fourth imaging device 4 is glued between the reflective lens 41 of the fourth imaging device 4 and one side (side d) of the prism 6. As such, the light output by the image display 5 passes through the first imaging device 1 and enters the second imaging device 2 after being reflected by the polarization beam splitter film 61, then the light enters the third imaging device 3 after being reflected by the second imaging device 2 and transmitted by the polarization beam splitter film 61, and then the light enters the fourth imaging device after being reflected by the third imaging device 3 and transmitted by the polarization beam splitter film 61. The light entering the fourth imaging device 4 first enters the polarization plate 42 of the fourth imaging device 4, and then enters the transmissive lens 41 of the fourth imaging device 4. The polarization plate 42 of the fourth imaging device 4 performs stray light filtering on the light entering the fourth imaging device 4, so that the light subjected to stray light filtering enters the transmissive lens 41 of the fourth imaging device 4, as shown in FIG. 12. Therefore, the light output from the transmissive lens 41 of the fourth imaging device 4 may form image in human eyes, and the image formed by a plurality of lenses of the optical assembly has a high imaging quality.

In some embodiments, the lens of each imaging device may be implemented by a single lens. To further improve the imaging quality, the lens of each imaging device may further be a cemented lens, that is, a lens group including a plurality of single lenses, so as to increase the number of lenses that the light passes through, thereby improving the light imaging quality.

In some embodiments, the prism 6 has a cubical structure, and the prism 6 includes two parts—a first right-angle prism 62 and a second right-angle prism 63. The first right-angle prism 62 and the second right-angle prism 63 are in contact with each other through inclined surfaces to form the cubical structure prism 6. To implement the optical path conversion of the light, the first right-angle prism 62 is provided with a beam splitter film 64 at the inclined surface, and/or a beam splitter film 65 is arranged at the inclined surface of the second right-angle prism 63, as described in more detail below.

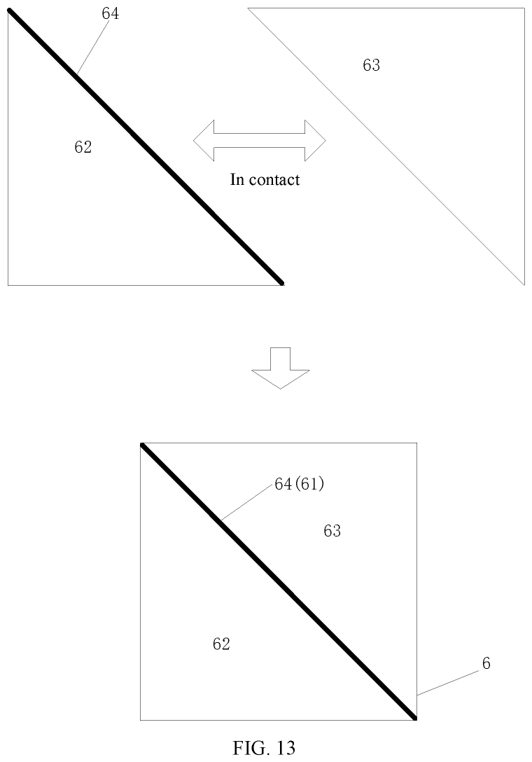

In some embodiments, only the inclined surface of the first right-angle prism 62 of the prism 6 is provided with the beam splitter film 64, as shown in FIG. 13. After the first right-angle prism 62 and the second right-angle prism 63 are brought into contact with each through the inclined surfaces, the beam splitter film 64 is equivalent to the above-described beam splitter film 61. Thus, the beam splitter film 64 is configured to reflect or transmit light so that the optical path of the light after the light passing through the lens of the first imaging device 1 can be converted, such that the light passing through the lens of the first imaging device 1 is output after the light passes through the lens of the second imaging device 2, the lens of the third imaging device 3, and the lens of the fourth imaging device 4. The optical path conversion through the beam splitter film 64 enables the light output by the image display for the image to be output to passes through the lenses of the imaging devices of the optical assembly sequentially, thereby improving the imaging quality of the output light.

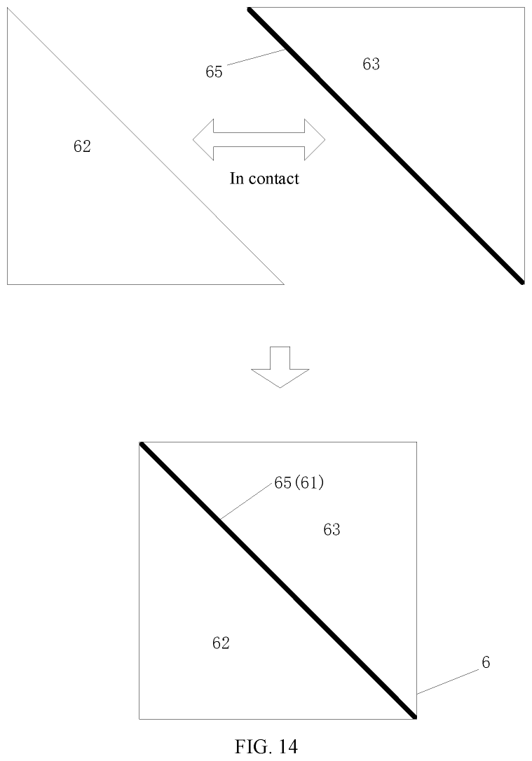

In some embodiments, only the inclined surface of the second right-angle prism 63 of the prism 6 is provided a beam splitter film 65, as shown in FIG. 14. When the first right-angle prism 62 and the second right-angle prism 63 are brought into contact with each other through the inclined surfaces, the beam splitter film 65 is equivalent to the above-described beam splitter film 61. Thus, the beam splitter film 65 is configured to reflect or transmit light so that the optical pass of the light passing through the lens of the first imaging device 1 can be converted, such that the light passing through the lens of device 1 is output after the light passes through the lens of the second imaging device 2, the lens of the third imaging device 3, and the lens of the fourth imaging device 4. The optical path conversion through the beam splitter film 65 enables the light output by the image display for the image to be output to pass through the lenses of the imaging devices of the optical assembly sequentially, thereby improving the imaging quality of the output light.

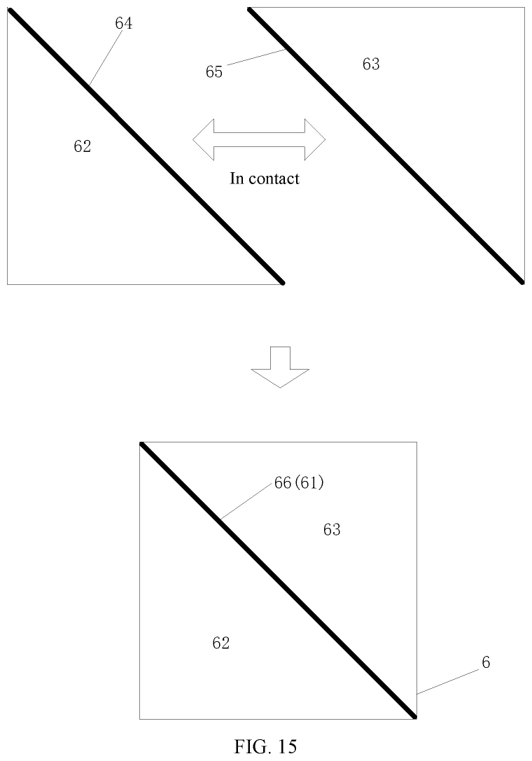

In some embodiments, not only the inclined surface the first right-angle prism 62 of the prism 6 is provided with the beam splitter film 64, but also the second right-angle prime 62 is provided with a beam splitter film 65, as shown in FIG. 15. Since the inclined surfaces of the first right-angle prism 62 and the second right-angle prism 63 are in contact with each other, the beam splitter film 64 and the beam splitter film 65 form a thickened beam splitter film 66, and the beam splitter film 66 is equivalent to the above-described beam splitter film 61. Thus, the beam splitter film 66 is configured to reflect or transmit light so that the optical path of the light passing through the lens of the first imaging device 1 can be converted, such that the light passing through the lens of the first imaging device 1 is output after the light passes through the lens of the second imaging device 2, the lens of the third imaging device 3, and the lens of the fourth imaging device 4. The optical path conversion by the beam splitter film 66 enables the light output by the image display for the image to be output to pass through the lenses of the imaging devices of the optical assembly sequentially, thereby improving the imaging quality of the output light.

Reflection or transmission of the light entering the optical assembly by the beam splitter film 66 is similar to that by the above-described beam splitter film 61. Reference can be made to the reflection or transmission described above with reference to FIG. 3 to FIG. 12, and detailed description is omitted here.

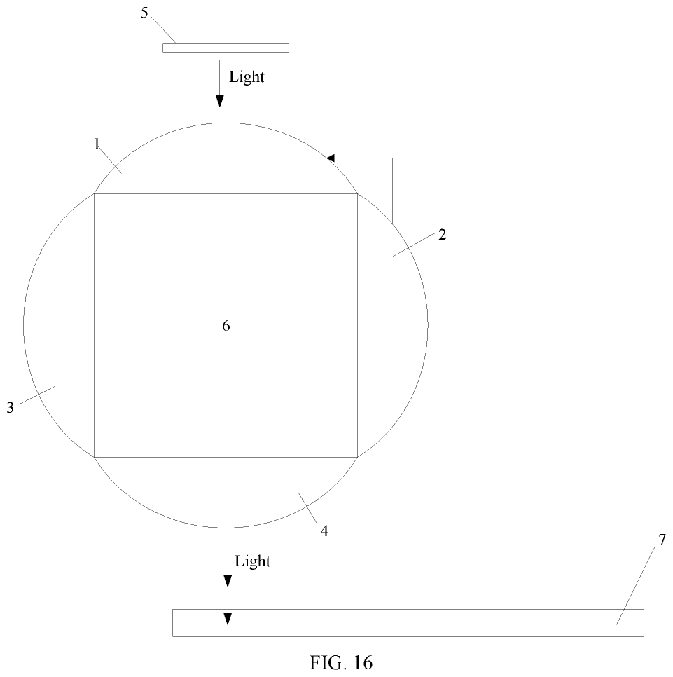

In some embodiments, the optical assembly further includes the following structures shown in FIG. 16.

A waveguide 7 is configured to perform optical path expansion on the light output from the lens of the fourth imaging device 4, so as to the light expanded by the waveguide enters the human eye.

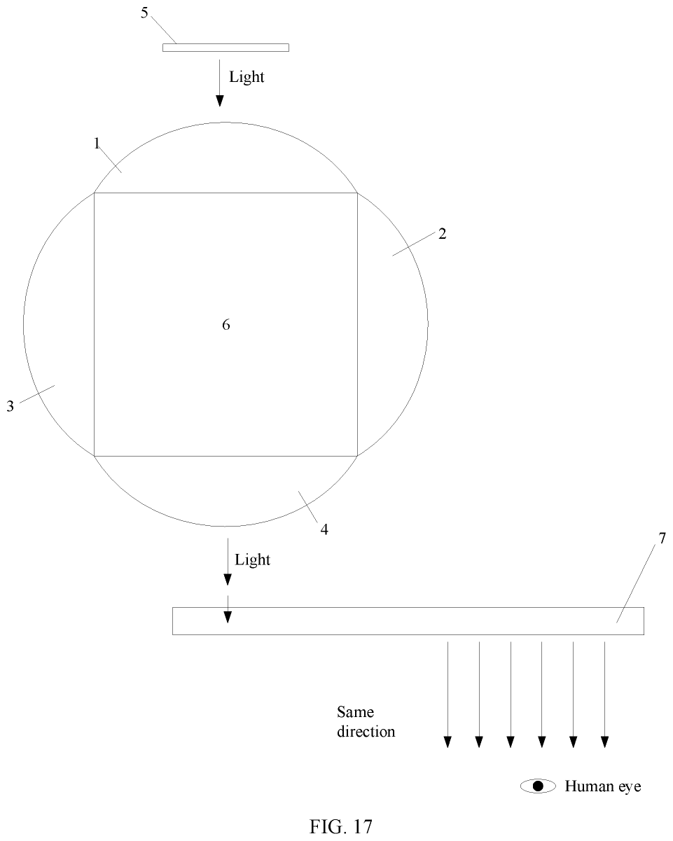

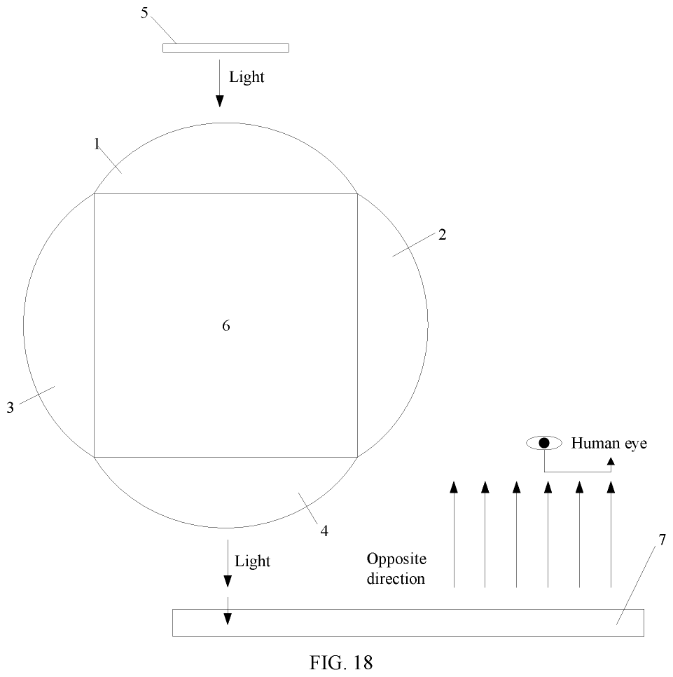

In some embodiments, an exit direction of light expanded by the waveguide 7 is the same as or opposite to the exit direction of the light output from the lens of the fourth imaging device 4, and the exit direction of the light expanded by the waveguide 7 is determined by a position of the eye of the user using the optical assembly. For example, if the user's eye is at the position where the exit direction of the light output by the lens of the fourth imaging device 4 is facing, the exit direction of the light expanded by the waveguide 7 is the same as the light output from the lens of the fourth imaging device 4, as shown in FIG. 17. When the user's eye is at a position back of the exit direction of the light output by the lens of the fourth imaging device 4, the exit direction of the light expanded by the waveguide 7 is opposite to the exit direction of the light output from the lens of the fourth imaging device 4, as shown in FIG. 18.

In some embodiments, the exit direction of the light expanded by the waveguide 7 may be set by the user according to the user's need or automatically adjusted according to the user's eye position.

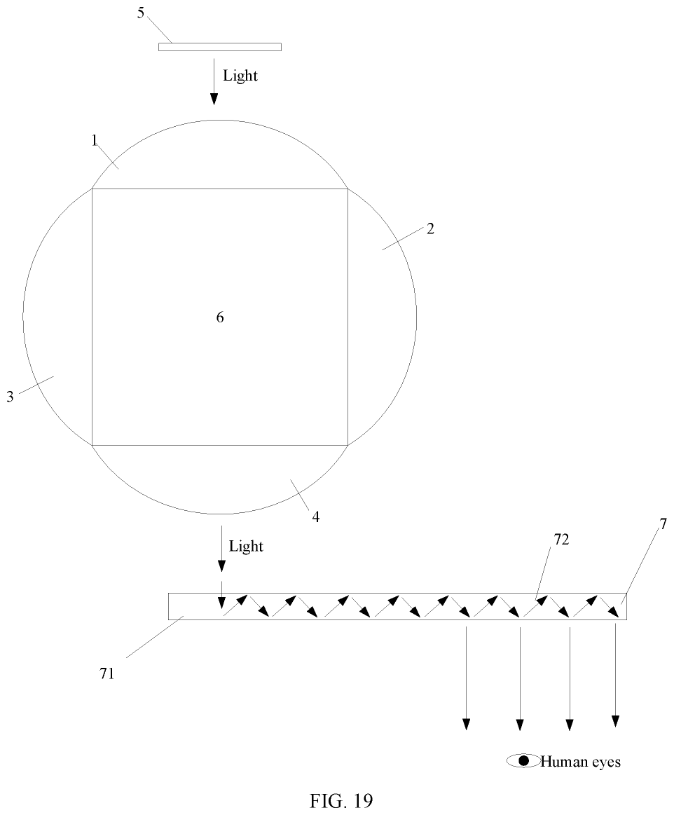

In some embodiments, the waveguide 7 includes at least a light input end 71 and a light output end 72. As shown in FIG. 19, the light input end 71 is arranged facing the fourth imaging device 4, so that the light output from the lens of the fourth imaging device 4 may enter the waveguide 7 through the light input end 71. Moreover, the facing direction of the light output end 72 is flexibly arranged according to the use needs of the optical assembly. For example, the facing direction of the light output end 72 is arranged to match the exit direction of the light output by the lens of the fourth imaging device 4, or the facing direction of the light output end 72 is opposite to the exit direction of the light output by the lens of the fourth imaging device 4, so that the light with optical path expanded by the waveguide 7 may enter the human eye after being output.

In some embodiments, the waveguide may be a geometric waveguide or a holographic waveguide.

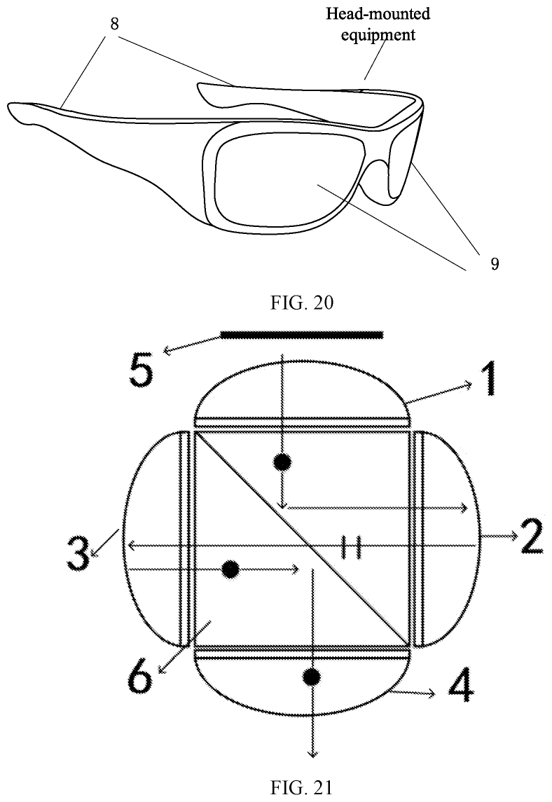

FIG. 20 is a schematic structural diagram of a head-mounted apparatus according to an embodiment of the present disclosure. The head-mounted apparatus may be an apparatus such as smart glasses. The head-mounted apparatus may be configured to form an image. The technical solution of some embodiments is mainly configured to improve the imaging quality of the optical assembly.

In some embodiments, the head-mounted apparatus may include the following structures.

A body 8 is configured to allow the head-mounted apparatus to be worn at the head and can be, for example, a spectacle frame that can be mounted with various assemblies.

An optical assembly 9 is arranged at the body 8, where the optical assembly 9 includes the following structures shown in FIG. 1.

The cubical structure prism 6, the first imaging device 1, the second imaging device 2, the third imaging device 3, and the fourth imaging device 4.

In some embodiments, the first imaging device 1, the second imaging device 2, the third imaging device 3, and the fourth imaging device 4 all include lenses. The lens of the first imaging device 1, the lens of the second imaging device 2, the lens of the third imaging device 3, and the lens of the fourth imaging device 4 are arranged at the four sides of the prism 6, respectively, and the four imaging devices are arranged symmetrically with the prism 6 as a center.

The optical assembly further includes the image display 5. The image display 5 is configured to output light to the first imaging device 1.

The prism 6 is configured to perform optical path conversion on the light after the light passes through the first imaging device 1, so that the light passing through the lens of the first imaging device 1 can be output after passing through the lens of the second imaging device 2, the lens of the third imaging device 3, and the lens of the fourth imaging device 4.

In some embodiments, the optical assembly 9 is detachably connected to the body 8, which facilitates removal of the optical assembly 9 from the body 8 or installation the optical assembly 9 at the body 8.

For details of each member of the head-mounted apparatus, reference may be made to the description above, which is not repeated in detail here.

Virtual reality (VR) glasses are taken as an example. In an imaging system of existing glasses, imaging lenses may be only arranged in one or two directions. Thus, a defect of low imaging quality may exist. Thus, a polyhedral polarization reentry virtual display device, that is, the above-described optical assembly, is provided to solve the low imaging quality technical problem in existing VR glasses. In the optical assembly, the optical path may be folded through the solution of polarization reentry, so that the volume of the optical structure is compressed. The polyhedral structure of the device may include imaging lenses in a plurality of dimensions to improve the imaging quality and provide more design freedoms, as described in more detail below.

An entire device structure is shown in FIG. 21, including the image display source 5 (i.e., the image display 5 above), the first imaging device 1, the second imaging device 2, the third imaging device 3, the fourth imaging device 4, and the polarization prism 6. The first imaging device 1 and the fourth imaging device 4 each include a transmissive lens and a polarization plate. The imaging device 2 and the third imaging device 3 each include a reflective lens and a 1/4 wave plate (i.e., a quarter-wave plate). The polarization prism 6 includes two right-angle prisms, The inclined side of the right-angle prism is coated with a polarization beam splitter film, which is configured to select to perform transmit or reflect on the incident polarized light.

The working principle of the device in the present disclosure is described below in conjunction with the optical path shown in FIG. 21.

The light emitted by the image display source 5 passes through the transmissive lens of the first imaging device 1 and becomes polarized light after passing through the polarization plate. The polarized light is reflected by the polarization splitting surface of the polarization prism 6, and then reaches the second imaging device 2 and is reflected by the reflective lens of the second imaging device 2. Because the light passes through the quarter-wave plate of the second imaging device 2 twice, the polarization state of the polarized light changes. When the light reaches the polarization splitting surface of the polarization prism 6 again, the light is transmitted. Then the transmitted polarized light reaches the third imaging device 3 and is reflected by the reflective lens of the third imaging device 3. Since the light passes through the quarter-wave plate of the third imaging device device3 twice, the polarization state is changed again. When the light reaches the polarization splitting surface of the polarization prism 6, the light is reflected into the fourth imaging device 4, then the light is output by the fourth imaging device 4. In some embodiments, the polarization plate of the fourth imaging device 4 may be configured to filter the stray light of the beam to ensure the optical imaging quality.

In some embodiments, the polarization plates of the first imaging device 1 and the fourth imaging device 4 are attached to the lens surfaces, the quarter-wave plates of the second imaging device 2 and the third imaging device 3 are attached to the lens surfaces, and each polarization plate and quarter-wave plate may be glued to the polarization prism 6, which makes the structure simpler.

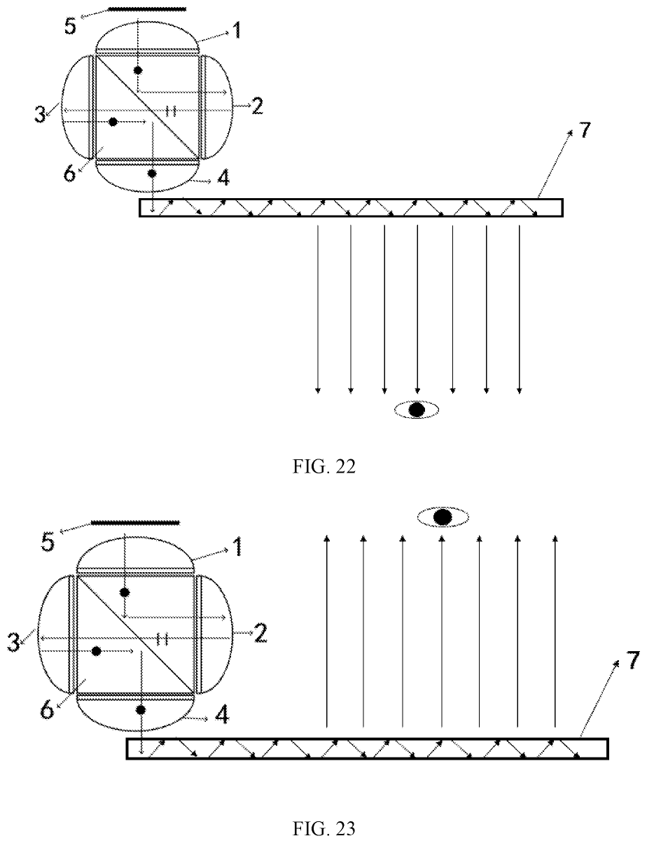

In addition, an expanding light beam emitted from the fourth imaging device 4 may be coupled into the waveguide 7, such as a geometric optical waveguide or a holographic waveguide, as shown in FIG. 22 and FIG. 23. The transmitted light expanded by the waveguide 7 exits the waveguide 7 and enters human eyes.

Various embodiments of the present disclosure are described progressively. Each embodiment focuses on the differences from other embodiments. For same or similar parts between different embodiments, reference can be made to each other.

The above description of the embodiments of the present disclosure enables those skilled in the art to implement or use this application. Various modifications to these embodiments are obvious to those skilled in the art, and the general principles defined herein can be implemented in other embodiments without departing from the spirit or scope of the disclosure. Therefore, the present disclosure is not limited to the embodiments in the specification, but should conform to the widest scope consistent with the principles and novel features disclosed in the specification.

What is claimed is:

1. An optical assembly comprising:
a prism having a cubical structure;
a first imaging device, a second imaging device, a third imaging device, and a fourth imaging device each including a lens, the lens of the first imaging device, the lens of the second imaging device, the lens of the third imaging device, and the lens of the fourth imaging device being arranged at four sides of the prism, respectively, and the first imaging device, the second imaging device, the third imaging device, and the fourth imaging device being arranged symmetrically with the prism as a center; and
an image display, the image display outputting light to the lens of the first imaging device;
wherein the prism performs optical path conversion on the light after the light passes through the lens of the first imaging device, so that the light is output after passing through the lens of the second imaging device, the lens of the third imaging device, and the lens of the fourth imaging device.

2. The optical assembly of claim 1, wherein the prism includes:
a first right-angle prism and a second right-angle prism in contact with each other through inclined surfaces of the first right-angle prism and the second right-angle prism, at least one of the inclined surfaces being provided with a beam splitter film, the beam splitter film reflecting or transmitting the light.

3. The optical assembly of claim 1, wherein:
the prism includes a beam splitter film arranged at a diagonal cross-section of the prism, the beam splitter film reflecting or transmitting the light.

4. The optical assembly of claim 3, wherein the beam splitter film:
reflects the light from the lens of the first imaging device to the lens of the second imaging device;
transmits the light from the lens of the second imaging device to the lens of the third imaging device; and
reflects the light from the third imaging device in sequence to the lens of the fourth imaging device.

5. The optical assembly of claim 4, wherein:
the beam splitter film includes a polarization beam splitter film;
the lens of the first imaging device includes a transmissive lens; and
the first imaging device further includes a polarization plate glued between the transmissive lens and one side surface of the prism.

6. The optical assembly of claim 4, wherein:
the beam splitter film includes a polarization beam splitter film;
the lens of the second imaging device includes a reflective lens; and
the second imaging device further includes a quarter-wave plate glued between the reflective lens and one side surface of the prism.

7. The optical assembly of claim 4, wherein:
the beam splitter film includes a polarization beam splitter film;
the lens of the third imaging device includes a reflective lens; and
the third imaging device further includes a quarter-wave plate glued between the reflective lens and one side surface of the prism.

8. The optical assembly of claim 4, wherein:
the beam splitter film includes a polarization beam splitter film;
the lens of the fourth imaging device includes a transmissive lens; and
the fourth imaging device further includes a polarization plate glued between the transmissive lens and one side surface of the prism.

9. The optical assembly of claim 1, further comprising:
a waveguide, the waveguide performs optical path expansion on the light output from the lens of the fourth imaging device;
wherein an exit direction of the light output from the waveguide is same as or opposite to an exit direction of the light output from the lens of the fourth imaging device.

10. A head-mounted apparatus comprising:
a body; and
an optical assembly arranged at the body and including:
a prism having a cubical structure;
a first imaging device, a second imaging device, a third imaging device, and a fourth imaging device each including a lens, the lens of the first imaging device, the lens of the second imaging device, the lens of the third imaging device, and the lens of the fourth imaging device being arranged at four sides of the prism, respectively, and the first imaging device, the second imaging device, the third imaging device, and the fourth imaging device being arranged symmetrically with the prism as a center; and
an image display, the image display outputting light to the first imaging device;
wherein the prism performs optical path conversion on the light after the light passes through the lens of the first imaging device, so that the light is output after passing through the lens of the second imaging device, the lens of the third imaging device, and the lens of the fourth imaging device.

11. The head-mounted apparatus of claim 10, wherein the prism includes:
a first right-angle prism and a second right-angle prism in contact with each other through inclined surfaces of the first right-angle prism and the second right-angle prism, at least one of the inclined surfaces being provided with a beam splitter film, the beam splitter film reflecting or transmitting the light.

12. The head-mounted apparatus of claim 10, wherein:
the prism includes a beam splitter film arranged at a diagonal cross-section of the prism, the beam splitter film reflecting or transmitting the light.

13. The head-mounted apparatus of claim 12, wherein the beam splitter film:
reflects the light from the lens of the first imaging device to the lens of the second imaging device;
transmits the light from the lens of the second imaging device to the lens of the third imaging device; and
reflects the light from the third imaging device in sequence to the lens of the fourth imaging device.

14. The head-mounted apparatus of claim 13, wherein:
the beam splitter film includes a polarization beam splitter film;
the lens of the first imaging device includes a transmissive lens; and
the first imaging device further includes a polarization plate glued between the transmissive lens and one side surface of the prism.

15. The head-mounted apparatus of claim 13, wherein:
the beam splitter film includes a polarization beam splitter film;
the lens of the second imaging device includes a reflective lens; and
the second imaging device further includes a quarter-wave plate glued between the reflective lens and one side surface of the prism.

16. The head-mounted apparatus of claim 13, wherein:
the beam splitter film includes a polarization beam splitter film;
the lens of the third imaging device includes a reflective lens; and
the third imaging device further includes a quarter-wave plate glued between the reflective lens and one side surface of the prism.

17. The head-mounted apparatus of claim 13, wherein:
the beam splitter film includes a polarization beam splitter film;
the lens of the fourth imaging device includes a transmissive lens; and
the fourth imaging device further includes a polarization plate glued between the transmissive lens and one side surface of the prism.

18. The head-mounted apparatus of claim 10, wherein the optical assembly further includes:
a waveguide, the waveguide performs optical path expansion on the light output from the lens of the fourth imaging device, an exit direction of the light output from the waveguide being same as or opposite to an exit direction of the light output from the lens of the fourth imaging device.
